(19) United States
(12) Patent Application Publication
(10) Pub. No.: US 2010/0220623 A1
(43) Pub. Date: Sep. 2, 2010

(54) METHOD AND APPARATUS FOR EXTENDING COVERAGE FOR UL TRANSMISSION OVER E-DCH IN IDLE MODE AND CELL_FACH STATE

(75) Inventors: Christopher R. Cave, Montreal (CA); Benoit Pelletier, Montreal (CA); Diana Pani, Montreal (CA); Paul Marinier, Brossard (CA); Rocco DiGirolamo, Laval (CA); Hong Zhang, Edison, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/715,856

(22) Filed: Mar. 2, 2010

Related U.S. Application Data
(60) Provisional application No. 61/156,572, filed on Mar. 2, 2009.
(60) Provisional application No. 61/234,096, filed on Aug. 14, 2009.

(51) Int. Cl. H04L 12/26; H04W 40/00; H04W 36/00

(52) U.S. Cl. 370/252; 370/328; 370/331

(57) ABSTRACT

A method and apparatus for transmitting an uplink (UL) transmission over an enhanced dedicated channel (E-DCH) includes determining whether to activate transmission time interval (TTI) bundling based upon a condition. An indication of the use of TTI bundling based upon the determination is transmitted. The UL transmission is transmitted.

### CROSS REFERENCE TO RELATED APPLICATIONS

This application claims the benefit of U.S. Provisional Application No. 61/156,572 filed Mar. 2, 2009, and 61/234,096, filed Aug. 14, 2009, which are incorporated by reference as if fully set forth herein.

### FIELD OF INVENTION

This application is related to wireless communications.

### BACKGROUND

As part of the ongoing evolution of wireless communications systems, the enhanced dedicated channel (E-DCH) in CELL_FACH state feature was introduced into wireless standard specifications, such as the third generation partnership project (3GPP) Release 8 specifications. Wireless transmit/receive units (WTRUs) operating in a CELL_FACH or IDLE mode may use a contention based E-DCH channel for uplink (UL) transmission rather than a traditional random access channel (RACH). The contention-based E-DCH channel allows for WTRUs to transfer signaling and data at significantly higher data rates and for longer durations, which reduces transfer and state transition delays with an aim to provide a user experience that is closer to “always-on connectivity.”

Support for multiple transmission time interval (TTI) settings, (e.g., 2 ms and 10 ms), are allowed for the E-DCH in the CELL_FACH state. A single TTI setting, which may be determined and broadcast by the network, for example the universal mobile telecommunications system (UMTS) terrestrial radio access network (UTRAN), may be used by all WTRUs accessing the E-DCH in the CELL_FACH state within a particular cell. While a smaller TTI, such as the 2 ms TTI, may be more advantageous from scheduling and latency standpoints, a larger TTI, such as the 10 ms TTI, may allow for a larger coverage area. Accordingly, the 10 ms TTI setting is often used throughout larger cells to allow for WTRUs, including those located near the cell edge, to reliably transfer signaling and data to the network.

Although the 10 ms TTI setting is used in some cases to ensure service reliability throughout the cell, it may desirable to take advantage of the fast scheduling and lower latency benefits of the 2 ms TTI. A number of methods to extend the coverage provided by the 2 ms TTI for E-DCH transmission in CELL_FACH have been proposed, such as TTI bundling. The application of TTI bundling for UL transmission using the E-DCH in CELL_FACH state may be used to improve the coverage with a smaller TTI, such as 2 ms TTI. However, a number of issues may need to be addressed. For example, it may need to be determined whether or not to apply TTI bundling. In addition, there may be a need to signal the support and use of TTI bundling by the WTRU and network.

It would therefore be beneficial to provide a method and apparatus for extending coverage for UL transmission over the E-DCH in IDLE Mode, CELL_PCH, and CELL_FACH state.

### SUMMARY

A method and apparatus for transmitting an uplink (UL) transmission over an enhanced dedicated channel (E-DCH) is disclosed. The method includes determining whether to activate transmission time interval (TTI) bundling based upon a condition. An indication of the use of TTI bundling based upon the determination is transmitted. The UL transmission is transmitted.

### BRIEF DESCRIPTION OF THE DRAWINGS

A more detailed understanding may be had from the following description, given by way of example in conjunction with the accompanying drawings wherein:

FIG. 1 shows an example wireless communication system including a plurality of WTRUs, a Node-B, a controlling radio network controller (CRNC), a serving RNC (SRNC), and a core network;

FIG. 2 shows an example functional block diagram of WTRU and a Node-B of the wireless communication system of FIG. 1;

FIG. 3 is a flow diagram of an example method of extending coverage for UL transmission over the E-DCH in IDLE Mode and CELL_FACH state;

FIG. 4 shows an example functional block diagram of the WTRU in communication with the Node-B of FIG. 1, showing a plurality of logical, transport, and physical channels;

FIG. 5 is a flow diagram of an example method of determining whether to activate TTI bundling based upon downlink (DL) receive (Rx) power;

FIG. 6 is a flow diagram of an example method of determining whether to activate TTI bundling based on a last transmitted RACH or DPCCH preamble; and

FIG. 7 is a flow diagram of an example method of determining whether to activate TTI bundling based upon a power margin.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

When referred to hereafter, the terminology “enabling TTI bundle” includes but is not limited to “operating in TTI bundling mode”. Further, when referred to hereafter, the term “use TTI bundling” includes but is not limited to “to operate in TTI bundling mode” or “to have TTI bundling enabled”. When referred to hereafter, the term “common E-DCH” includes but is not limited to “E-DCH in CELL_FACH and IDLE_Mode”. However, it may be noted that although the use of TTI bundling is described below as an example range extension mechanism, the methods described herein may be utilized and applied to activating and indicating any range extension mechanism.

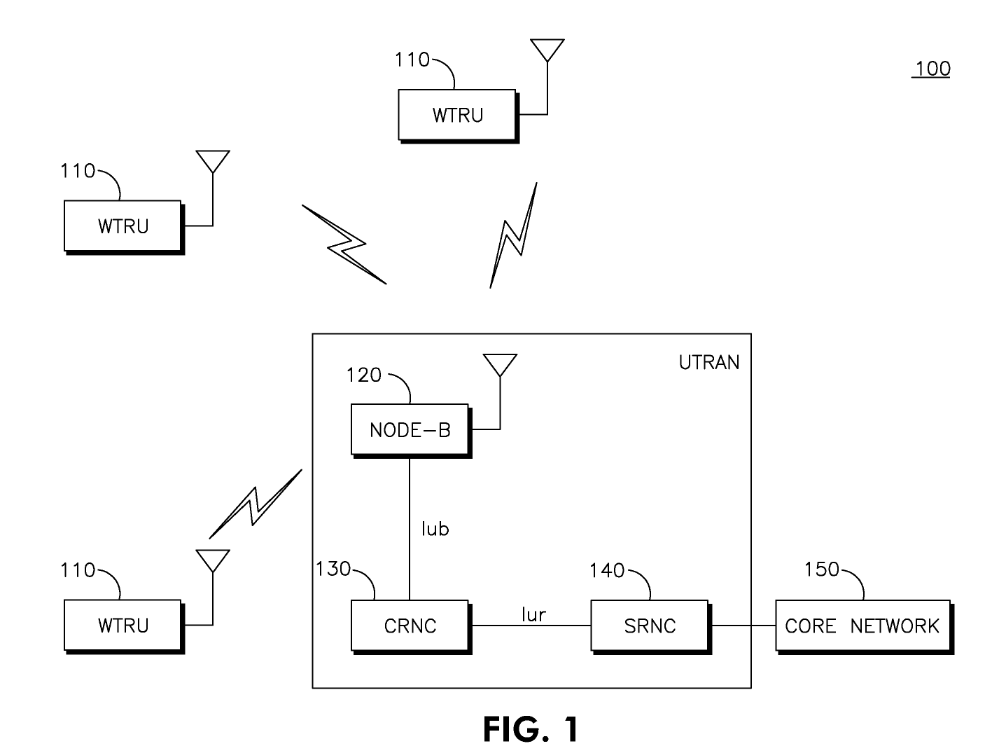

FIG. 1 shows a wireless communication system 100 including a plurality of WTRUs 110, a Node-B 120, a CRNC 130, an SRNC 140, and a core network 150. The Node-B 120 and the CRNC 130 may collectively be referred to as the UTRAN. As shown in FIG. 1, the WTRUs 110 are in communication with the Node-B 120, which is in communication with the CRNC 130 and the SRNC 140. Although three WTRUs 110, one Node-B 120, one CRNC 130, and one SRNC 140 are shown in FIG. 1, it should be noted that any combination of wireless and wired devices may be included in the wireless communication system 100.

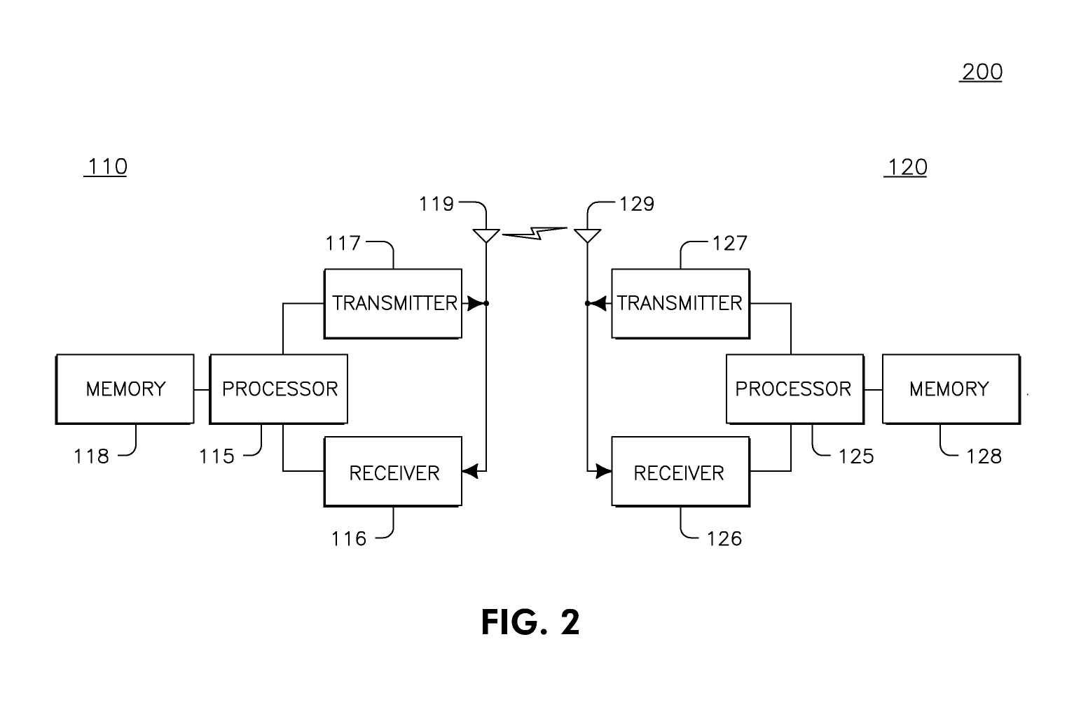

FIG. 2 is an example functional block diagram 200 of a WTRU 110 and the Node-B 120 of the wireless communication system 100 of FIG. 1. As shown in FIG. 2, the WTRU 110 is in communication with the Node-B 120 and both are configured to perform a method of transmission time interval (TTI) bundling

In addition to the components that may be found in a typical WTRU 110, the WTRU 110 includes a processor 115, a receiver 116, a transmitter 117, and an antenna 119. The processor 115 is configured to perform a method of transmission time interval (TTI) bundling in the WTRU 110. The receiver 116 and the transmitter 117 are in communication with the processor 115. The antenna 119 is in communication with both the receiver 116 and the transmitter 117 to facilitate the transmission and reception of wireless data. In addition, the WTRU 110 may include a memory 118 coupled to the processor 115.

In addition to the components that may be found in a typical Node-B, the Node-B 120 includes a processor 125, a receiver 126, a transmitter 127, and an antenna 128. The processor 125 is configured to perform a method of transmission time interval (TTI) bundling in the WTRU 110. The receiver 126 and the transmitter 127 are in communication with the processor 125. The antenna 128 is in communication with both the receiver 126 and the transmitter 127 to facilitate the transmission and reception of wireless data. In addition, the Node-B 120 may include a memory 128 coupled to the processor 125.

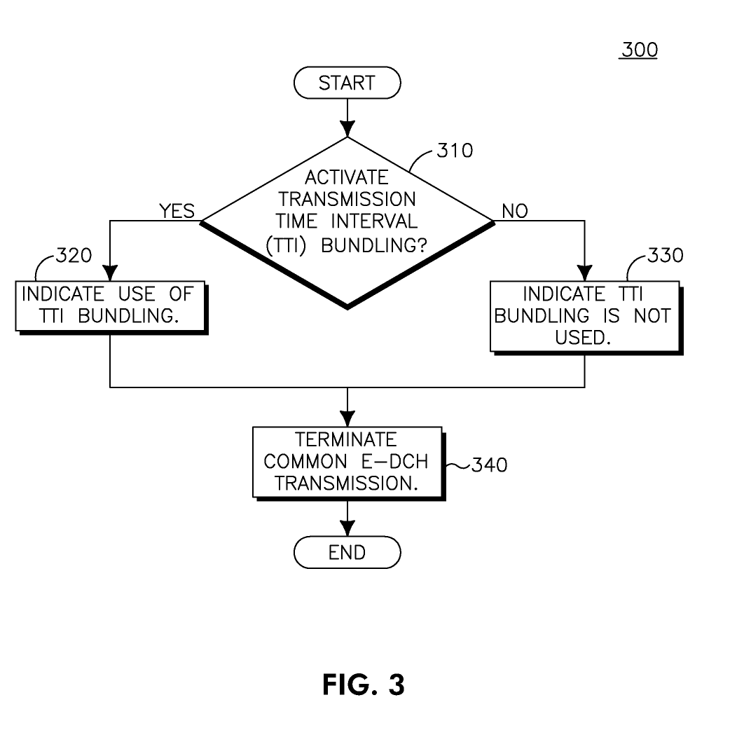

FIG. 3 is a flow diagram of an example method 300 of extending coverage for UL transmission over the E-DCH in IDLE Mode and CELL_FACH state. In step 310, whether or not to activate TTI bundling is determined. A more detailed discussion of the determination to activate TTI bundling or not will be discussed below. If TTI bundling is to be activated, the activation is indicated, such as in step 320. Otherwise, if TTI bundling is not to be activated, then the indication that it is not activated is indicated in step 330. In step 340, the common E-DCH transmission is terminated.

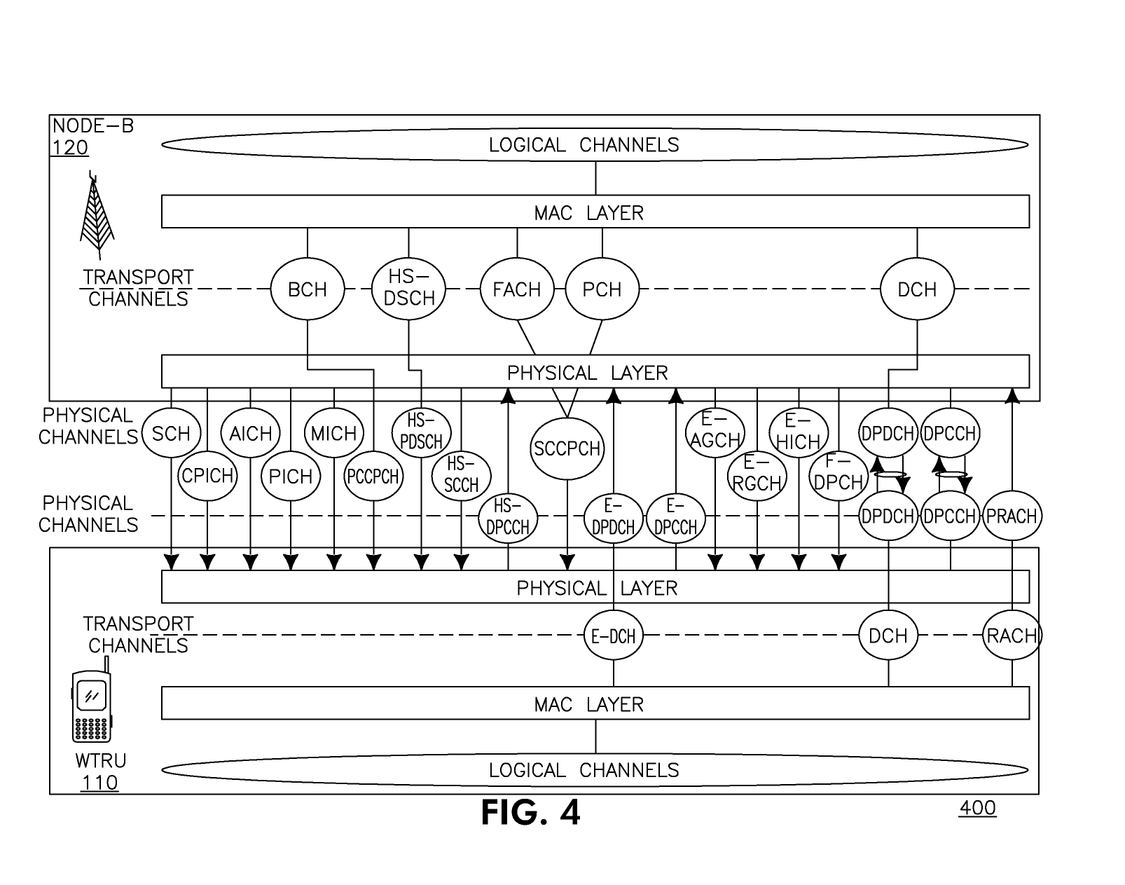

FIG. 4 shows an example functional block diagram of the WTRU 110 in communication with the Node-B 120 of FIG. 1, showing a plurality of logical, transport, and physical channels. The channels depicted in FIG. 4 are for example and other channels may be included that are not depicted in FIG. 4. In addition, some of the channels depicted may not be utilized in some cases.

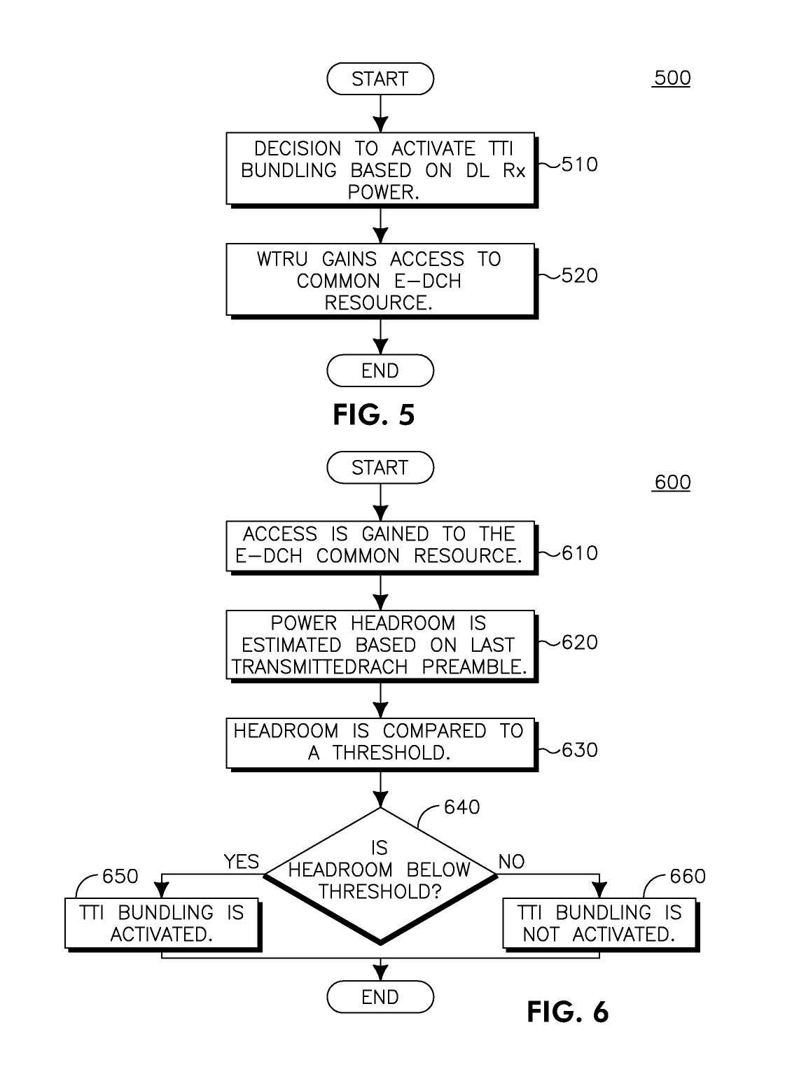

FIG. 5 is a flow diagram of an example method 500 of determining whether to activate TTI bundling based upon downlink (DL) receive (Rx) power. In step 510, a decision to activate TTI bundling is made based upon the DL Rx power. In step 520, the WTRU gains access to the E-DCH resource.

The determination in step 510 may be based on a number of parameters and measurements. For example, the determination may be based on the pilot or reference channel power, such as common pilot channel (CPICH) based measurements at the WTRU, (e.g., CPICH, receive signal code power (RSCP), or CPICH received Energy per Chip/power density in the band (Ec/No), and the like. For example, if the CPICH receive signal code power (RSCP) is below a pre-configured threshold, the WTRU may determine to activate TTI bundling, or another equivalent UL range extension mechanism. In addition, the determination may be based upon the received power at the WTRU such as the UMTS terrestrial radio access (UTRA) carrier received signal strength indicator (RSSI), or a power offset received from the network. A power offset received from the network may include, for example, a power offset between a last transmitted preamble and dedicated physical control channel (DPCCH) power, an enhanced DPCCH (E-DPCCH)/DPCCH power offset, or power backoff value that may be specific to TTI bundling determination or usage.

The transmit pilot power as indicated by the network is another example measurement that may be used. Also the acquisition indicator channel (AICH) power offset indicated by the network, (e.g., indicated on a system information base (SIB) such as SIB5 or SIB6) or paging indicator channel (PICH) power offset indicated by the network, (e.g., indicated on a system information base (SIB) such as SIB5 or SIB6) may be used to make the determination.

Other factors for making the determination based on the downlink Rx power include for example the UL interference reported by the network, for example in a SIB; power margin for TTI bundling, for example as configured by the network; a minimum enhanced transport format combination (E-TFC) value supported, for example, a minimum E-TFC set; maximum WTRU transmit power, for example as configured by the network; maximum WTRU power as per the WTRU class; and an initial preamble power, for example, as may be indicated in a variable Preamble Initial Power or calculated as part of an initial access attempt.

For example, the Preamble Initial Power may be calculated in accordance with the following equation:

Preamble Initial Power=Primary CPICH TX power−CPICH_RSCP+UL interference++Constant Value, Equation (1)

where Primary CPICH TX power has the value of an information element (IE) “Primary CPICH Tx power”, UL interference has the value of an IE “UL interference for common E-DCH” if a variable READY_FOR_COMMON_EDCH is set to TRUE, and an IE “UL interference for common E-DCH” is included in SIB 5/5bis. Otherwise, the UL interference has the value of an IE “UL interference”. Additionally, the Constant Value has the value of an IE “Constant Value”.

In one example of the above, if the Initial Preamble Power is above a certain threshold, (i.e., the WTRU requires a large amount of power to transmit in the UL), the WTRU may determine to activate TTI bundling or another UL range extension mechanism.

In another example, a “minimum E-TFC” parameter may be used. For example, if the sum of the Initial Preamble Power and additional power required for transmitting a transport block having the minimum E-TFC size exceed the maximum WTRU transmission power, (i.e., the WTRU would not have enough power to transmit the transport block), the WTRU may determine to activate TTI bundling

In another example of determining whether or not to activate TTI bundling in step 320, the WTRU 110 may calculate a power margin based on a path loss estimate and a maximum transmit power. If the WTRU 110 determines that it has an insufficient power margin to transmit E-TFCs in the minimum E-TFC set, the WTRU 110 may decide to operate in TTI bundling mode and activate TTI bundling.

In another example, the WTRU 110 may calculate a power margin and compare the calculated value of the power margin to a threshold that may be pre-determined or configured. If the power margin value is below the threshold, again the WTRU 110 may operate in TTI bundling mode and activate TTI bundling.

In yet another example, the WTRU 110 may compare a power preamble value, such as the value indicated in the variable “Preamble Initial Power”, to a pre-determined or configured threshold. If the power preamble value is above the threshold, the WTRU 110 may determine to operate in TTI bundling mode and activate TTI bundling.

FIG. 6 is a flow diagram of an example method 600 of determining whether to activate TTI bundling based on a last transmitted RACH or DPCCH preamble. In the method 600, access is gained to the common E-DCH resource (step 610).

In step 620, power headroom is estimated based on the power of the last transmitted RACH or DPCCH preamble. The power headroom is the amount of power available for the transmission of data and may calculated by subtracting the UL DPCCH power from the maximum transmit power. The power headroom estimate is compared against a threshold (step 630), which may be a pre-defined or configured threshold. If the power headroom is below the threshold (step 640), then TTI bundling is activated (step 650). TTI bundling may be activated during any remaining E-DCH access or for the first HARQ transmission of the E-DCH access. In the latter case, a re-evaluation of whether to activate TTI bundling may be performed on a TTI basis that is based on new estimated power headroom calculations or other criteria. In addition, it can be determined whether the headroom is sufficient to transmit with respect to a given or predefined E-TFC, and if it is not sufficient, to activate TTI bundling. If the estimated power headroom is not below the threshold in step 650, TTI bundling is not activated (step 660).

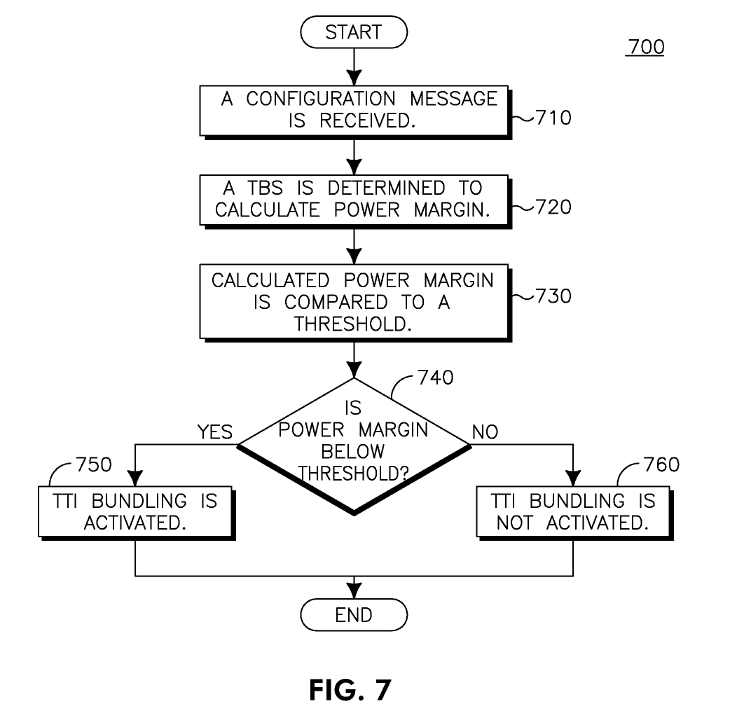

FIG. 7 is a flow diagram of an example method 700 of determining whether to activate TTI bundling based upon a power margin. The power margin may be calculated based upon a set of E-DCH parameters and TBS for the case of E-DCH in CELL_FACH and IDLE Mode. For example, in step 710, a configuration message is received. The configuration message, which may be in the form of configuration information received via RRC signaling or via the SIBs, for example, may contain one or more example threshold values, power offset values, and the like.

A transport block set (TBS) is then determined for which to calculate the power margin (step 720). The TBS may be predefined, for example in technical specifications, preconfigured and signaled by the network. Alternatively, the TBS may be calculated or have a value based on the transport block size that corresponds to the E-DCH minimum set E-TFC. The power margin is then calculated based on the power required to transmit a given TBS for the MAC-d flow that corresponds to the highest priority logical channel with data to transmit.

The calculated power margin is then compared to a threshold (step 730). If the power margin is below the threshold (step 740), then TTI bundling is activated for the upcoming E-DCH transmission (step 750). If the power margin is not below the threshold (step 740), then TTI bundling is not activated (step 760).

In another method for determining whether or not to activate TTI bundling, the determination may be made based on a buffer occupancy. For example, if the amount of data, or packet, to be transmitted in the uplink can be transmitted in a single transport block, TTI bundling may be activated so as to release the common E-DCH resource earlier.

In another method for determining whether or not to activate TTI bundling, the determination may be based upon an imminent cell reselection. Since, in some cases, a WTRU may not perform cell reselection during common E-DCH transmissions, interference in neighbor cells may be created where the common resource is maintained for an extended period of time. Accordingly, the indication of a pending cell reselection may be used to trigger the activation of TTI bundling. That is, when cell reselection conditions have been met, TTI bundling may be activated. In addition, this method may also be used in conjunction with activating TTI bundling based on buffer occupancy such that resources may be released earlier and interfering transmission duration may be reduced.

In addition, the activation of TTI bundling may be based on the logical channel that is to be transmitted. For example, the activation of TTI bundling could be determined differently for the CCCH than for the DTCH/DCCH. Any combination of the above criteria may be utilized to make the determination based on either channel.

As another example method for determining whether to activate TTI bundling, the determination may be made based on whether or not the collision resolution phase is completed. A device, for example a WTRU, may be configured to enable TTI bundling, use TTI bundling or check the conditions for TTI bundling. That is, the activation of TTI bundling may occur only before the collision resolution is completed, for example. Alternatively, TTI bundling may be prevented before collision resolution is completed.

It can be noted that any of the above methods for determining whether or not to use TTI bundling may be performed by the WTRU 110, the Node-B 120, or another network entity.

Referring back now to FIG. 3, once it is determined whether or not to activated TTI bundling in step 310, that determination is indicated in steps 320 and 330, (i.e., whether TTI bundling is activated or not, respectively). In one example, where the WTRU 110 makes the determination whether to activate TTI bundling, the WTRU 110 may transmit a signal to the Node-B 120 indicating the status of whether or not TTI bundling is activated.

For example, two sets of preambles may be defined and signaled on the system information. A first set may be selected by WTRUs 110 that are utilizing TTI bundling, (i.e., have activated TTI bundling), whereas the second set may be used by WTRUs 110 that are not using TTI bundling. Accordingly, the network may know which WTRUs have TTI bundling active and which do not by determining which set the preamble used by the WTRUs belong to.

Another way of indicating whether or not TTI bundling is being used may be for the WTRU 110 to set one or a combination of bits, for example on the E-DPCCH or DPCCH, to a predefined value, such as a “happy bit”. In this way, the bit, or bits, may be reinterpreted as an indication of whether or not TTI bundling has been activated. This reinterpretation of the happy bit may continue until an event occurs to restore the normal meaning of the happy bit. For example, the normal meaning may be restored upon successful contention resolution, expiration of a timer started at reception of AICH/E-AICH or at transmission of the first E-DCH. It might be beneficial in this case for all WTRUs to understand the reinterpreted meaning of the happy bit regardless of whether they support TTI bundling in IDLE Mode and CELL_FACH, so that the network may know whether or not the WTRU transmitting the happy bit supports TTI bundling or not.

In another alternative method of indicating whether or not TTI bundling is activated, scrambling codes may be assigned to one or more sets of E-DCH resources that are signaled by the network, (e.g., through the AICH and E-AICH). A first scrambling code may be utilized where TTI bundling is activated, while a second scrambling code may be used where TTI bundling is not activated. The WTRU 110 may then transmit the E-DCH using the first scrambling code where TTI bundling is activated and using the second scrambling code where TTI bundling is not activated.

In another alternative method, the network, or UTRAN, may reserve a set of E-DCH resources for TTI bundling purposes. In this case, different sets of preamble signatures could be signaled where one set is associated with normal common E-DCH operation and one for TTI bundling common E-DCH operation. Each available signature for TTI bundling may be associated with one of the common E-DCH resource configurations in the “common E-DCH resource configuration list”, with one list provided for both TTI bundling and non TTI bundling. Alternatively, each available signature may be associated with one of the common E-DCH resource configuration in a new broadcasted information element (IE), such as a “common E-DCH resource configuration list for TTI Bundling” IE. One of the TTI bundling signatures that are available may be selected where the WTRU 110 determines that TTI bundling will be activated.

In the case where the UTRAN determines whether or not to use TTI bundling, the WTRU 110 may signal a desire to use TTI bundling and the UTRAN may acknowledge the request in the acquisition indication (AI). One way of performing this may be transmitting by using a reserved part of the AICH channel, (e.g., the last 1024 chips), or by using special processing of extended acquisition indicators. For example, if “K” resources are used, the UTRAN may select from a set of “2K” signatures to respond on the E-AI. When the WTRU 110 calculates the E-DCH Resource configuration index, which may be referred to as “j”, the WTRU may determine the resource index from the relationship: j mod(K). The WTRU may determine whether to use TTI bundling or not if j is greater or less than K. For example, if j>K, it may be an indication to use the resource j mod(K) using TTI bundling.

Alternatively, the UTRAN may indicate use of TTI bundling by using the paging indicator (PI) transmitted on the PICH channel. This may include mapping PIs to PICH bits. For example, where the existing mapping of PIs to PICH bits are used to indicate whether there is an associated PCH transport channel for the WTRU, (e.g., PICH bits for the PI are all “0” or “1”), a mixed mapping pattern may be introduced where the PICH bits are not all 0 or 1, (e.g., 101010 . . . ), to indicate that the WTRU read the corresponding frame of the associated physical channel to which a PCH transport channel is mapped and also to indicate whether or not to use TTI bundling. The UTRAN may also utilize specific bits, for example the reserved last 12 bits of the PICH channel to signal the use of TTI bundling.

Referring again to FIG. 3, in step 340, the determination to activate TTI bundling may trigger the termination of a common E-DCH resource. A new E-DCH transmission with a TTI bundle indication may then be transmitted. The methods described above may be applicable when both the WTRU 110 and network support TTI bundling for a common E-DCH and the TTI bundling feature is enabled. The TTI bundling feature may be enabled by default, for example, enabled when both the WTRU and network support TTI bundling. The TTI bundling feature may by explicitly signaled by the network, for example in a system information base (SIB) or explicitly via radio resource control (RRC) messages. Further, the methods described above may be used alone or in combination with one other.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for transmitting an uplink (UL) transmission over an enhanced dedicated channel (E-DCH) implemented in a wireless transmit/receive unit (WTRU), comprising:
the WTRU determining whether to activate transmission time interval (TTI) bundling based upon a condition;
the WTRU transmitting an indication of the use of TTI bundling based upon the determination; and
the WTRU transmitting the UL transmission.

2. The method of claim 1 wherein the determination is based upon a downlink (DL) receive (Rx) power determination.

3. The method of claim 2, further comprising:
calculating a power margin based on a pathloss estimate and maximum transmit power; and
activating TTI bundling on a condition that the power margin is insufficient to transmit enhanced transport format combinations (E-TFCs) in the minimum set.

4. The method of claim 1, wherein the determining whether to activate TTI bundling further comprises:
determining a power of a last transmitted random access channel (RACH) preamble;
estimating a power headroom based upon the last transmitted RACH preamble;
comparing the estimated power headroom to a threshold; and
activating TTI bundling based upon the comparison.

5. The method of claim 4 wherein TTI bundling is activated on a condition that the estimated power headroom is below the threshold.

6. The method of claim 4, further comprising gaining access to a common E-DCH resource.

7. The method of claim 1 wherein TTI bundling is activated on a condition that a packet can be transmitted in a single transport block.

8. The method of claim 1 wherein the determining whether to activate TTI bundling further comprises:
determining whether a cell reselection is imminent; and
activating TTI bundling based upon the determination that a cell reselection is imminent.

9. The method of claim 1 wherein the determining whether to activate TTI bundling further comprises:
receiving a configuration message containing at least one threshold value;
determining a transport block set (TBS) for a power margin calculation;
calculating the power margin;
comparing the power margin to the threshold; and
activating TTI bundling based upon the comparison.

10. The method of claim 9 wherein TTI bundling is activated on a condition that the power margin is below the threshold.

11. The method of claim 1 wherein the determining whether to activate TTI bundling further comprises:
determining a logical channel to be transmitted; and
activating TTI bundling based upon the determination.

12. The method of claim 11 wherein TTI bundling is activated on a condition that a common control channel (CCCH) is to be transmitted.

13. The method of claim 1 wherein the determining whether to activate TTI bundling further comprises:
determining whether a collision resolution phase is completed; and
activating TTI bundling based upon the determination.

14. The method of claim 1, further comprising terminating a common E-DCH transmission.

15. A wireless transmit/receive unit (WTRU), comprising:
a receiver;
a transmitter; and
a processor in communication with the receiver and the transmitter, the processor configured to determine whether to activate transmission time interval (TTI) bundling based upon a condition, transmit an indication of the use of TTI bundling based upon the determination, and transmit the UL transmission.

16. The WTRU of claim 15 wherein the processor is further configured to calculate a power margin based on a pathloss estimate and maximum transmit power, and activate TTI bundling on a condition that the power margin is insufficient to transmit enhanced transport format combinations (E-TFCs) in the minimum set.

17. The WTRU of claim 15 wherein the processor is further configured to determine a power of a last transmitted random access channel (RACH) preamble, estimate a power headroom based upon the last transmitted RACH preamble, compare the estimated power headroom to a threshold, and activate TTI bundling based upon the comparison.

18. The WTRU of claim 15 wherein the processor is further configured to receive a configuration message containing at least one threshold value, determine a transport block set (TBS) for a power margin calculation, calculate the power margin, compare the power margin to the threshold, and activate TTI bundling based upon the comparison.

19. The WTRU of claim 15 wherein the processor is further configured to terminate a common E-DCH transmission.

20. An integrated circuit (IC), comprising:
a receiver;
a transmitter; and
a processor in communication with the receiver and the transmitter, the processor configured to determine whether to activate transmission time interval (TTI) bundling based upon a condition, transmit an indication of the use of TTI bundling based upon the determination, and transmit the UL transmission.
